(19) United States
(12) Patent Application Publication
(10) Pub. No.: US 2017/0016221 A1
(43) Pub. Date: Jan. 19, 2017

(54) TOILET SEAT APPARATUS AND TOILET BOWL APPARATUS

(71) Applicant: PANASONIC INTELLECTUAL PROPERTY MANAGEMENT CO., LTD., Osaka (JP)

(72) Inventors: Yasuko YAMAMOTO, Osaka (JP); Satoshi SUGINO, Osaka (JP)

(73) Assignee: PANASONIC INTELLECTUAL PROPERTY MANAGEMENT CO., LTD., Osaka (JP)

(21) Appl. No.: 15/102,285

(22) PCT Filed: Dec. 9, 2014
(86) PCT No.: PCT/JP2014/006130

§ 371 Date: Jun. 7, 2016

(30) Foreign Application Priority Data
Dec. 13, 2013 (JP) 2013-258063

(51) Int. Cl. E03D 5/10; G01S 13/56; A47K 13/24

(52) U.S. Cl. CPC E03D 5/105; A47K 13/24; G01S 13/56; E03D 9/08

(57) ABSTRACT

An objective would be to propose a toilet seat apparatus capable of detecting accurately various motions of a human body such as entering and leaving a restroom, sitting on and rising from a toilet seat. A human body detector (5) includes a frequency analyzer (52c), a recognizer (52e), and a database device (52i) storing sample data. The frequency analyzer (52c) converts a sensor signal into a frequency domain signal, and extracts signals of individual filter banks with different frequency bands. The recognizer (52e) has functions of detecting a human body entering a space where at least a toilet bowl (11) is installed and a human body of a person sitting on a toilet seat (12b) based on comparison between the sample data and detection data containing a frequency distribution of signals based on the signals of the individual filter banks (5a).

### TECHNICAL FIELD

The present invention generally relates to toilet seat apparatuses and toilet bowl apparatuses, and particularly relates to a toilet seat apparatus and a toilet bowl apparatus for detecting a human body of a person entering a room, sitting on a seat, or the like.

### BACKGROUND ART

In the past, there have been provided a toilet seat apparatus and a toilet bowl apparatus which include a human body detector using a wireless signal and supplies water for flushing in response to detection of motion of a user such as entering and leaving a restroom (e.g., see JP 3740696 B2). The human body detector includes a Doppler sensor and is to detect motion of the human body based on comparison between output of the Doppler sensor filtered with a low bandpass filter and a threshold value.

The human body detector for the toilet seat apparatus and/or the toilet bowl apparatus is required to detect various motions such as sitting on the toilet seat, in addition to entering and leaving the room of the user.

However, the conventional human body detector for the toilet seat apparatus and/or the toilet bowl apparatus is likely to cause false detection of detecting motion different from actual motion of the user, and other false detection of detecting the human body when the user is absent.

### SUMMARY OF INVENTION

In view of the above insufficiency, an objective of the present invention would be to propose a toilet seat apparatus and a toilet bowl apparatus which are capable of detecting accurately various motions of a human body such as entering and leaving a restroom, sitting on and rising from a toilet seat.

A toilet seat apparatus of one aspect of the present invention includes: a body to be placed on a toilet bowl; a toilet seat attached to the body so as to be movable between an up-position and a down-position; and a human body detector configured to detect a human body as an object to be detected. The human body detector includes: a sensor configured to send a wireless signal and receive the wireless signal reflected by an object to output a sensor signal corresponding to motion of the object; a frequency analyzer configured to convert the sensor signal into a frequency domain signal, and extract, by use of a group of individual filter banks with different frequency bands, signals of the individual filter banks from the frequency domain signal; a recognizer configured to perform a recognition process of detecting predetermined motion of the human body based on detection data containing at least one of a frequency distribution of signals based on the signals of the individual filter banks and a component ratio of signal intensities based on the signals of the individual filter banks; and a database device configured to store sample data containing at least one of a frequency distribution corresponding to the predetermined motion of the human body and a component ratio of signal intensities corresponding to the predetermined motion of the human body. The recognizer includes: a first detection function of detecting, by performing the recognition process based on comparison between the detection data and the sample data, the human body of a person entering a space in which at least the toilet bowl is installed; and a second detection function of detecting, by performing the recognition process based on comparison between the detection data and the sample data, the human body of a person sitting on the toilet seat.

A toilet bowl apparatus of one aspect of the present invention includes: the toilet seat apparatus of the above aspect of the present invention; and the toilet bowl on which the body of the toilet seat apparatus is placed.

The toilet bowl apparatus and the toilet seat apparatus of the aspects of the present invention can offer effect of detecting accurately various motions of a human body such as entering and leaving a restroom and sitting on and rising from a toilet seat.

### BRIEF DESCRIPTION OF DRAWINGS

FIG. 1 is a block diagram of a configuration of a toilet bowl apparatus of one embodiment.

FIG. 2 is a perspective view of an appearance of the toilet bowl apparatus according to the embodiment.

FIG. 3A to FIG. 3C are explanatory diagrams of a normalizer of a signal processor according to the embodiment.

FIG. 4A to FIG. 4C are explanatory diagrams of a smoothing processor according to the embodiment.

FIG. 5A to FIG. 5C are explanatory diagrams of one example of a background signal remover according to the embodiment.

FIG. 6 is an explanatory diagram of another example of the background signal remover according to the embodiment.

FIG. 7A and FIG. 7B are explanatory diagrams of another example of the background signal remover according to the embodiment.

FIG. 8 is a block diagram of an adaptive filter serving as another example of the background signal remover according to the embodiment.

FIG. 9A to FIG. 9C are explanatory views of a recognition process based on principle component analysis of the signal processor according to the embodiment.

FIG. 10 is an explanatory diagram of a recognition process based on multiple linear regression analysis of the signal processor according to the embodiment.

FIG. 11A and FIG. 11B are other explanatory diagrams of the recognition process based on multiple linear regression analysis of the signal processor according to the embodiment.

FIG. 12A and FIG. 12B are explanatory diagrams of the signal processor according to the embodiment.

FIG. 13 is an explanatory diagram of a group of filter banks according to the embodiment.

FIG. 14 is a flow chart of operation according to the embodiment.

FIG. 15 is a transition diagram of modes of a controller according to the embodiment.

FIG. 16 is a block diagram of a configuration of a frequency analyzer according to the embodiment.

FIG. 17A to FIG. 17C are waveform diagrams of individual waveforms in respiration detection according to the embodiment.

FIG. 18 is an explanatory diagram of a respiration detection process according to the embodiment.

FIG. 19A and FIG. 19B are explanatory diagrams of operation in distance measurement according to the embodiment.

FIG. 20 is a waveform chart of a beat signal in distance measurement according to the embodiment.

FIG. 21A to FIG. 21D are waveform charts of output waveforms in distance measurement according to the embodiment.

### DESCRIPTION OF EMBODIMENTS

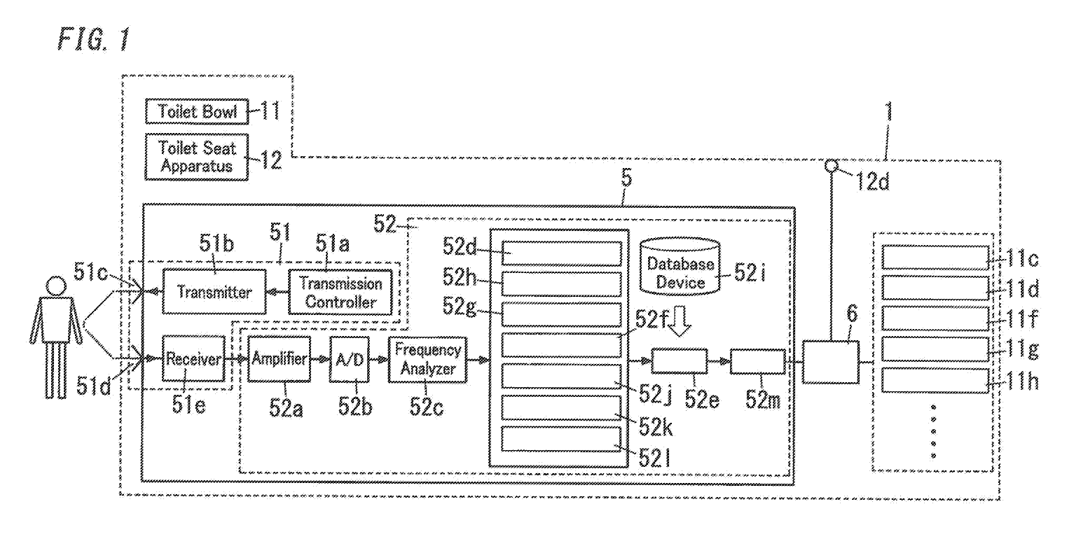

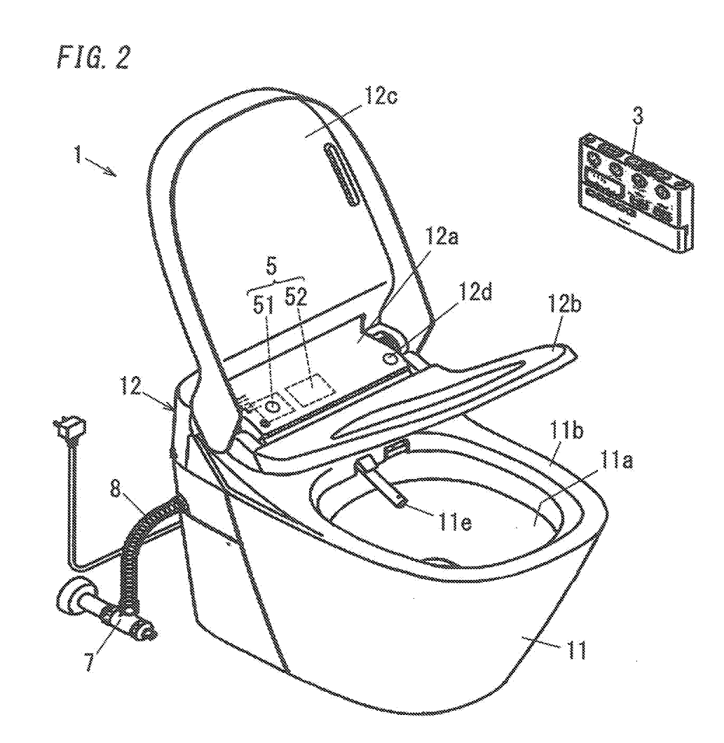

FIG. 1 shows a block configuration of a toilet bowl apparatus 1 of the present embodiment. FIG. 2 shows an appearance of the toilet bowl apparatus 1. The toilet bowl apparatus 1 includes main components including a toilet bowl 11, a toilet seat apparatus 12, and a human body detector 5.

The toilet bowl 11 is a western-style toilet and includes a bowl 11a in a recessed shape, and a rim 11b formed at an outer edge of the bowl 11a (shown in FIG. 2). The toilet bowl 11 incorporates a flusher 11c, a bottom washer 11d, a detergent supplier 11f, a lighting controller 11g, and a lifter 11h (shown in FIG. 1). The flusher 11c is configured to supply water into the bowl 11a and drain water from the bowl 11a. The bottom washer 11d includes a washing nozzle 11e protruding into the bowl 11a to wash a bottom of a human body, and the washing nozzle 11e supplies water for bottom washing (shown in FIG. 2). The detergent supplier 11f is configured to supply detergent for cleaning the bowl 11a. The lighting controller 11g is configured to turn on and off a lighting fixture inside a restroom. The lifter 11h is configured to lift and lower a toilet seat 12b and a toilet lid 12c. Water used by the flusher 11c and the bottom washer 11d is supplied from a stopcock 7 provided to a wall of the restroom, via a water service pipe 8. Note that, the flusher 11c and the bottom washer 11d serve as a water supply device for supplying water into the bowl 11a of the toilet bowl 11.

The toilet seat apparatus 12 is placed on an upper face of the rim 11b of the toilet bowl 11. The toilet seat apparatus 12 includes a toilet seat body 12a placed on a rear side of the upper face of the rim 11b, and the toilet seat 12b and the toilet lid 12c attached to the toilet seat body 12a in a rotatable manner. The toilet seat 12b and the toilet lid 12c are movable between their down-positions and their up-positions over an upper face of the toilet bowl 11 by the lifter 11h including a motor or the like.

The toilet bowl apparatus 1 includes a controller 6 configured to control operations of the flusher 11c, the bottom washer 11d, the detergent supplier 11f, the lighting controller 11g, and the lifter 11h. The controller 6 may be provided to either one of the toilet bowl 11 and the toilet seat apparatus 12.

There is a remote controller 3 installed on the wall of the restroom. The remote controller 3 includes manual operation switches for operating the flusher 11c, the bottom washer 11d, and the lifter 11h, and sends operation signals such as infrared signals according to manual operations of the manual operation switches. The toilet seat body 12a of the toilet seat apparatus 12 is provided with a receiver 12d for receiving the operation signals sent from the remote controller 3. The controller 6 shown in FIG. 1 controls operations of the flusher 11c, the bottom washer 11d, and the lifter 11h according to the operation signals received by the receiver 12d.

Further, the human body detector 5 is provided to the toilet seat body 12a of the toilet seat apparatus 12. The human body detector 5 is configured to detect motions of a human body such as entering and leaving the restroom of a user (realized by a first detection function) and sitting on and rising from the toilet seat 12b of the user (realized by a second detection function). Hereinafter, the human body detector 5 is described in detail.

As Shown in FIG. 1, the Human Body Detector 5 Includes a Sensor 51 and a Signal Processor 52.

The sensor 51 may be a Doppler sensor. The Doppler sensor sends a radio wave with a predetermined frequency to a detection area, and receives a radio wave reflected by an object moving in the detection area, and outputs a sensor signal with a Doppler frequency corresponding to a difference between frequencies of the sent radio wave and the received radio wave. Therefore, a sensor signal is an analog time axis signal corresponding to motion of the object. Note that, when the object reflecting the radio wave is moving in the detection area, a frequency of a reflection wave is shifted by the Doppler effect. In the present embodiment, the object to be detected includes motions of the human body in the restroom (e.g., entering and leaving the room, and sitting on and rising from the seat).

As shown in FIG. 1, the sensor 51 includes a transmission controller 51a, a transmitter 51b, a transmission antenna 51c, a reception antenna 51d, and a receiver 51e.

The transmitter 51b is configured to send a radio wave to the detection area through the transmission antenna 51c. The transmission controller 51a is configured to control a frequency and a sending timing of the radio wave sent from the transmitter 51b, for example. The radio wave sent from the transmitter 51b may be a millimeter wave with the frequency of 24.15 GHz, for example. The radio wave sent from the transmitter 51b is not limited to a millimeter wave and may be a micro wave. Further, this value is one example of the frequency of the radio wave to be sent from the transmitter 51b, and there is no intent to limit the frequency to this value.

The receiver 51e is configured to receive the radio wave reflected by the object in the detection area through the reception antenna 51d, and output the sensor signal having a frequency corresponding to a difference between frequencies of the sent radio wave and the received radio wave. In more detail, the receiver 51e separates the sensor signal into signals of two channels which are an in-phase component and a quadrature phase component, and outputs them.

The signal processor 52 has a function of performing signal processing on the sensor signal outputted from the sensor 51.

As shown in FIG. 1, the signal processor 52 includes an amplifier 52a configured to amplify the sensor signal, and an A/D converter 52b configured to convert the sensor signal amplified by the amplifier 52a into a digital sensor signal and output the digital sensor signal. The amplifier 52a may include an amplifier including an operational amplifier, for example. In more detail, the amplifier 52a is configured to amplify a signal of the in-phase component and a signal of the quadrature phase component. The A/D converter 52b is configured to convert the signal of the in-phase component and the signal of the quadrature phase component into digital signals.

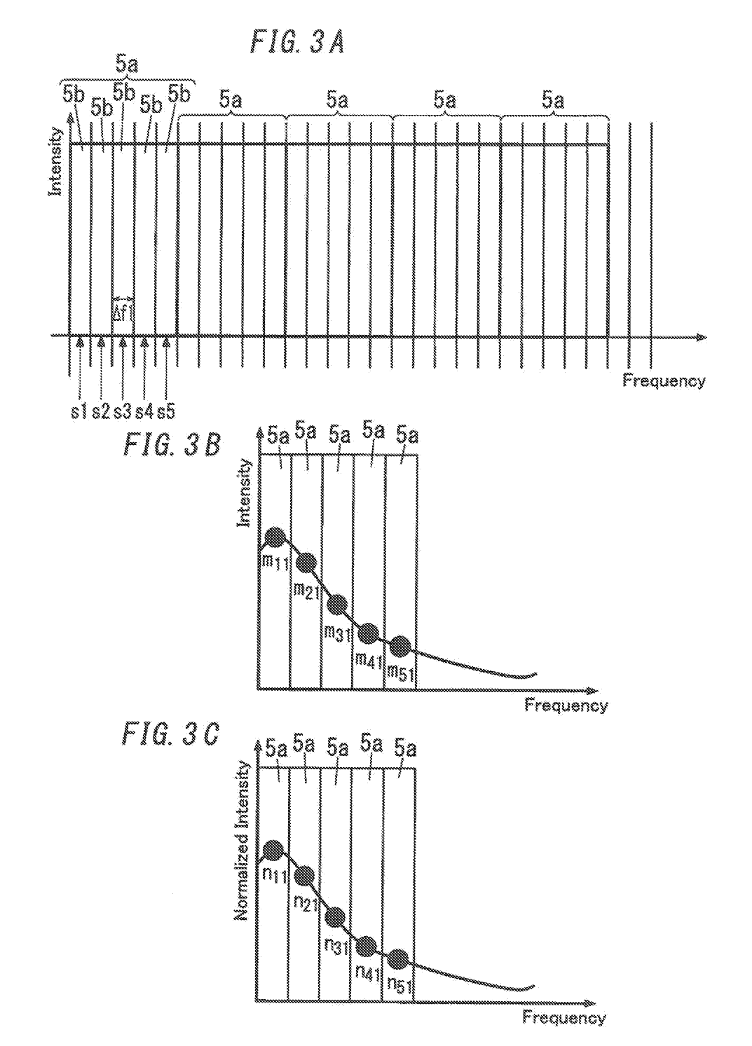

As shown in FIG. 1, the signal processor 52 further includes a frequency analyzer 52c. The frequency analyzer 52c is configured to convert a time domain sensor signal outputted from the A/D converter 52b into a frequency domain signal (frequency axis signal) and extract, by use of a group of individual filter banks 5a (shown in FIG. 3A) with different frequency bands, signals of the individual filter banks 5a from the frequency domain signal.

In the frequency analyzer 52c, a predetermined number of (for example, sixteen) filter banks 5a is set as a group of filter banks 5a. However, this number is one example, and there is no intent to limit the number of filter banks 5a in one group to this number.

Further, the signal processor 52 includes a normalizer 52d. The normalizer 52d is configured to normalize intensities of the signals individually passing through the individual filter banks 5a by a sum of intensities of the signals extracted by the frequency analyzer 52c or a sum of intensities of signals individually passing through a plurality of predetermined filter banks 5a (for example, four filter banks on a lower frequency side) selected from the individual filter banks 5a to obtain normalized intensities, and output the normalized intensities.

As shown in FIG. 1, the signal processor 52 further includes a recognizer 52e configured to perform a recognition process of detecting the object based on a frequency distribution calculated from the normalized intensities of the individual filter banks 5a outputted from the normalizer 52d.

The aforementioned frequency analyzer 52c has a function of converting the sensor signal outputted from the A/D converter 52b into the frequency domain signal by Discrete Cosine Transform (DCT). Further, as shown in FIG. 3A, each of the individual filter banks 5a includes a plurality of (in the illustrated example, five) frequency bins 5b. The frequency bin 5b of the filter bank 5a using DCT may be referred to as a DCT bin, in some cases. Each of the filter banks 5a has resolution depending on widths (Δf1 in FIG. 3A) of the frequency bins 5b. With regard to each of the filter banks 5a, this number is one example of the number of frequency bins 5b, and there is no intent to limit the number of frequency bins 5b to this number. The number of frequency bins 5b may be two or more other than five or may be one. Orthogonal transform for converting the sensor signal outputted from the A/D converter 52b into the frequency domain signal is not limited to DCT, and, for example may be Fast Fourier Transformation (FFT). The frequency bin 5b of the filter bank 5a using FFT may be referred to as an FFT bin, in some cases. Further, the orthogonal transform for converting the sensor signal outputted from the A/D converter 52b into the frequency domain signal may be Wavelet Transform (WT).

When each of the filter banks 5a includes a plurality of frequency bins 5b, it is preferable that the signal processor 52 include a smoothing processor 52f between the frequency analyzer 52c and the normalizer 52d. It is preferable that this smoothing processor 52f have at least one of following two smoothing processing functions (a first smoothing processing function and a second smoothing processing function). The first smoothing processing function is a function of performing smoothing processing on intensities of signals of the individual frequency bins 5b in a frequency domain (frequency axis direction) for each of the individual filter banks 5a. The second smoothing processing function is a function of performing smoothing processing on intensities of signals of the individual frequency bins 5b in a time axis direction for each of the individual filter banks 5a. Accordingly, the signal processor 52 can reduce undesired effects caused by noises, and more reduce the undesired effects caused by noises when the both functions are included.

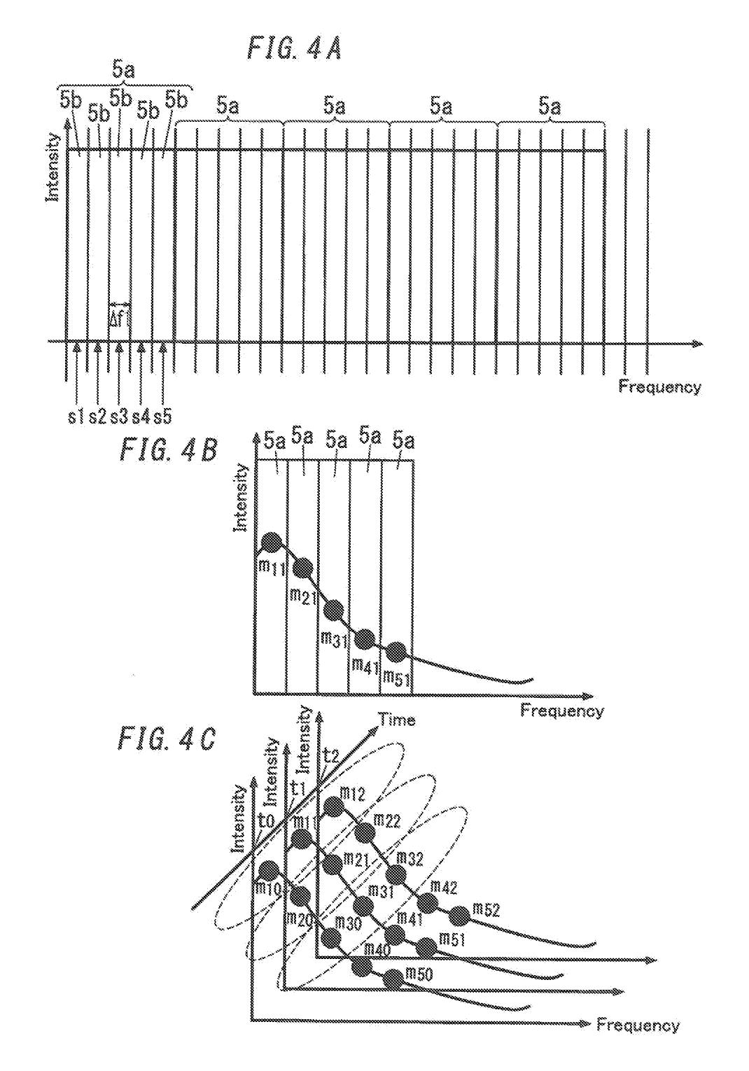

The first smoothing processing function can be realized by use of, for example, an average filter, a weighted average filter, a median filter, a weighted median filter, or the like. When the first smoothing processing function is realized by use of an average filter, as shown in FIG. 3A and FIG. 4A, it is assumed that, at time t₁, intensities of signals of the individual five frequency bins 5b of the filter bank 5a which is the first one from the lower frequency side are represented by s1, s2, s3, s4, and s5, respectively. In this regard, with regard to the first filter bank 5a, when it is assumed that the intensity of the signal obtained by the smoothing processing by the first smoothing processing function is m₁₁ (see FIG. 3B and FIG. 4B), m₁₁ is equal to (s1+s2+s3+s4+s5)/5.

Similarly, as shown in FIG. 3B and FIG. 4B, the signals of the second filter bank 5a, the third filter bank 5a, the fourth filter bank 5a, and the fifth filter bank 5a are represented by m₂₁, m₃₁, m₄₁ and, m₅₁, respectively. In summary, in the present embodiment, for convenience of explanation, mⱼᵢ represents the intensity of the signal obtained by the smoothing processing realized by the first smoothing processing function on the signal of the j-th (“j” is a natural number) filter bank 5a at time tᵢ (“i” is a natural number) in the time axis.

The normalizer 52d normalizes the intensities of the signals passing through the individual filter banks 5a by the sum of the intensities of the signals passing through the plurality of predetermined filter banks 5a used in the recognition process by the recognizer 52e. In this regard, in the following explanation, it is assumed that, for example, the total number of filter banks 5a in the frequency analyzer 52c is sixteen, and the plurality of predetermined filter banks 5a used for the recognition process are only the five filter banks which are the first to fifth filter banks from the lower frequency side. When the normalized intensity of the intensity m₁₁ of the signal passing through the first filter bank 5a at the time tᵢ is n₁₁ (see FIG. 3C), the normalizer 52d can calculate the normalized intensity n₁₁ by use of the relation of n₁₁=+m₂₁+m₃₁+m₄₁+m₅₁).

Further, when each of the filter banks 5a is constituted by one frequency bin 5b, the normalizer 52d extracts the intensities of the signals passing through the individual filter banks 5a, and normalizes the intensities of the signals passing through the individual filter banks 5a by the sum of the intensities of these.

Further, the second smoothing processing function can be realized by use of, for example, an average filter, a weighted average filter, a median filter, a weighted median filter, or the like. In a case where the second smoothing processing function is realized by use of an average filter of calculating an average of intensities of a signal at a plurality of (for example, three) points in the time axis direction, as shown in FIG. 4C, with regard to the first filter bank 5a, when it is assumed that the intensity of the signal obtained by the smoothing processing by the second smoothing processing function is m₁, m₁ is equal to (m₁₀+m₁₁+m₁₂)/3.

Similarly, when it is assumed that the intensities of the signals of the second filter bank 5a, the third filter bank 5a, the fourth filter bank 5a and the fifth filter bank 5a are represented by m₂, m₃, m₄ and m₅, m₂ is equal to (m₂₀+m₂₄+m₂₂)/3, and m₃ is equal to (m₃₀+m₃₁+m₃₂)/3, and m₄ is equal to (m₄₀+m₄₁+m₄₂)/3, and m₅ is equal to (m₅₀+m₅₄+m₅₂)/3.

In summary, in the present embodiment, for convenience of explanation, mₙ represents the intensity of the signal obtained by performing the smoothing processing by the first smoothing processing function on the signal of the n-th (“n” is a natural number) filter bank 5a and further performing the smoothing processing by the second smoothing processing function.

Additionally, it is preferable that the signal processor 52 include a background signal estimator 52g and a background signal remover 52h. The background signal estimator 52g is configured to estimate background signals (i.e., noise) included in the signals outputted from the individual filter banks 5a. The background signal remover 52h is configured to remove the background signals from the signals passing through the individual filter banks 5a.

It is preferable that the signal processor 52 have operational modes including, for example, a first mode of estimating the background signals and a second mode of performing the recognition process and the first mode and the second mode be switched alternately at a predetermined time period (for example, 30 seconds) timed by a timer. In this regard, it is preferable that the signal processor 52 operate the background signal estimator 52g in a period of the first mode, and remove the background signals with the background signal remover 52h and then perform the recognition process with the recognizer 52e in a period of the second mode. The period of the first mode and the period of the second mode are not limited to having the same length (for example, 30 seconds) but may be different lengths.

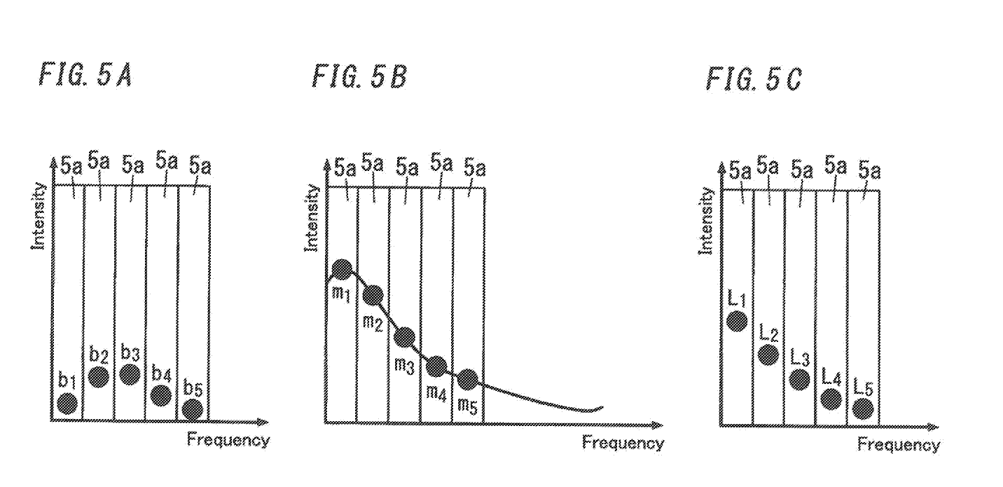

The background signal remover 52h may be configured to remove the background signals by subtracting the background signals from the signals outputted from the filter banks 5a, for example. In this case, the background signal remover 52h may include, for example, a subtractor configured to subtract the intensities b₁, b₂, . . . , (see FIG. 5A) of the background signals estimated by the background signal estimator 52g from the intensities of the signals m₁, m₂, . . . , (see FIG. 5B) passing through the individual filter banks 5a. FIG. 5C shows the intensities of the signals obtained by subtracting the background signals from the signals in the same filter bank 5a. In this regard, when L₁ represents the intensity of the signal of the first filter bank 5a from left, L₁ is equal to m₁−b₁.

Similarly, when it is assumed that the intensities of the signals obtained by subtraction of the background signals of the second filter bank 5a, the third filter bank 5a, the fourth filter bank 5a and the fifth filter bank 5a are represented by L₂, L₃, L₄ and L₅, L₂ is equal to m₂−b₂, and L₃ is equal to m₃−b₃, and L₄ is equal to m₄−b₄, and L₅ is equal to m₅−b₅.

The background signal estimator 52g may estimate the intensities of the signals obtained in the period of the first mode with regard to the individual filter banks 5a as the intensities of the background signals of the individual filter banks 5a, and then updates the background signals as needed. Further, the background signal estimator 52g may estimate an average of intensities of a plurality of signals obtained in the first mode with regard to each of the individual filter banks 5a as the intensity of the background signal of each of the individual filter banks 5a. In other words, the background signal estimator 52g may treat an average in a time axis of a plurality of signals obtained in advance for each of the individual filter banks 5a as the background signal. In this case, the background signal estimator 52g can have an improved estimation accuracy of the background signals.

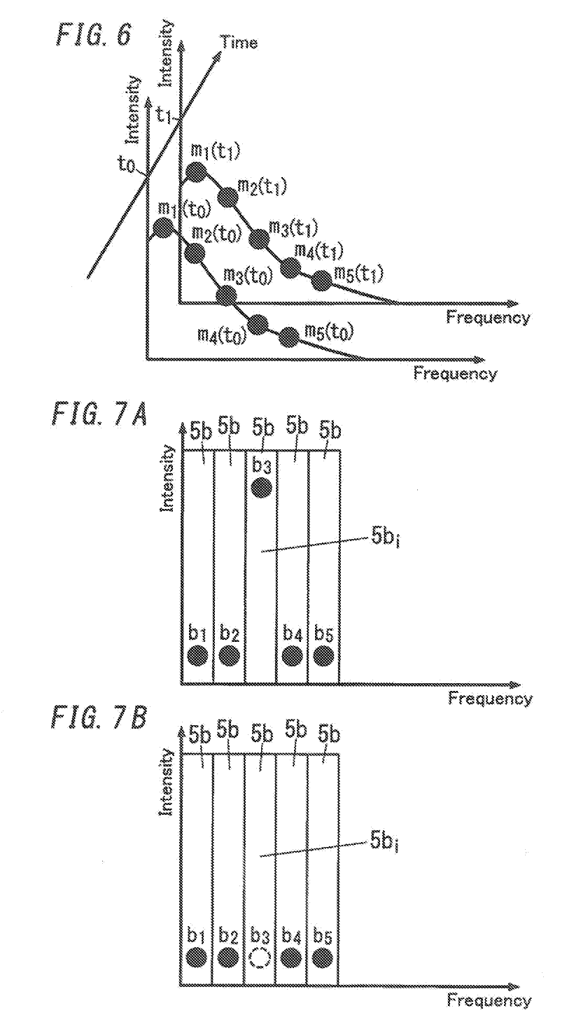

Further, the background signal remover 52h may treat an immediately preceding signal (i.e., a previous signal) of each of the filter banks 5a as the background signal. In this case, the signal processor 52 may have a function of removing the background signals by subtracting the immediately preceding signals in the time axis before the signals are subjected to the normalization process by the normalizer 52d. In summary, with regard to the signals passing through the individual filter banks 5a, the background signal remover 52h may have a function of removing the background signals by subtracting, from the intensities of the signals to be subjected to the normalization process, intensities of signals sampled at one point in the time axis before the signals to be subjected to the normalization process. In this case, for example, as shown in FIG. 6, when it is assumed that the signals of the individual filter banks 5a at the time t₁ to be subjected to the normalization process are represented by m₁(t₁), m₂(t₁), m₃(t₁), m₄(t₁) and m₅(t₄), and the signals at the time to immediately before the time tᵢ are represented by m₁(t₀), m₂(t₀), m₃(t₀), m₄(t₀) and m₅(t₀), and the intensities of the signals after the subtraction are represented by L₁, L₂, L₃, L₄ and L₅, L₁ is equal to m₁(t₁)−m₁(t₀), and L₂ is equal to m₂(t₁)−m₂(t₀), and L₃ is equal to m₃(t₁)−m₃(t₀), and L₄ is equal to m₄(t₁)−m₄(t₀), and L₅ is equal to m₅(t₄)−m₅(t₀).

In some cases, depending on circumstances of use of the signal processor 52, there is a possibility that the frequency bin 5b including a relatively large background signal (noise) may be known in advance. For example, in a case where apparatus to be energized by a commercial power source is present in a vicinity of the human body detector 5, there is a high possibility that relatively large background noise is included in the signal of the frequency bin 5b whose frequency band including a frequency (for example, 60 Hz, and 120 Hz) which is a relatively small multiple of a frequency of commercial power supply (for example, 60 Hz). Additionally, the background noise may include a mechanical signal of the toilet bowl apparatus 1, a fluctuation of a water surface inside the bowl 11a, and a noise of the lighting fixture, for example.

In contrast, with regard to the sensor signal outputted when the human body moves in the detection area, a frequency (Doppler frequency) of this sensor signal changes continuously according to a distance between the sensor 51 and the object and a moving speed of the object. In this case, the sensor signal does not occur constantly at a specific frequency.

In view of this, when the signal processor 52 is configured so that each of the individual filter banks 5a includes a plurality of frequency bins 5b, one of the frequency bins 5b in which the background signal is constantly included may be treated as a particular frequency bin 5bᵢ. The background signal remover 52h may be configured to remove the background signal by not using an intensity of an actual signal of the particular frequency bin 5bᵢ but replacing the intensity of the actual signal of the particular frequency bin 5bᵢ by an intensity of a signal estimated based on intensities of signals of two frequency bins 5b adjacent to the particular frequency bin 5bᵢ.

The third frequency bin 5b from left in FIG. 7A is assumed to be the particular frequency bin 5bᵢ. The background signal remover 52h treats the signal (signal intensity b₃) of the particular frequency bin 5bᵢ as being invalid, and as shown in FIG. 7B, replaces it with the intensity b₃ of the signal component estimated based on the intensities b₂ and b₄ of the signal components of the two frequency bins 5b adjacent to the particular frequency bin 5bᵢ. In the estimation, the estimated intensity b₃ of the signal is an average of the intensities b₂ and b₄ of the signal components of the two frequency bins 5b adjacent to the particular frequency bin 5bᵢ, that is, (b₂+b₄)/2. In summary, when it is assumed that the i-th frequency bin 5b from the lower frequency side in the filter bank 5a is treated as the particular frequency bin 5bᵢ and the intensity of the signal of the particular frequency bin 5bᵢ is represented by b₁, b₁ can be defined by an estimation formula of b₁=(bᵢ₋₁+bᵢ₊₁)/2.

Accordingly, the signal processor 52 can reduce, in a short time, undesired effects caused by background signals (noise) of a particular frequency which occurs constantly. Therefore, the signal processor 52 can have the improved detection accuracy of the human body.

The background signal remover 52h may be an adaptive filter configured to remove the background signal by filtering the background signal in a frequency domain (frequency axis).

The adaptive filter is a filter configured to adjust by itself a transfer function (filter coefficient) according to an adaptive algorithm (optimization algorithm), and can be realized by use of a digital filter. This type of adaptive filter may preferably be an adaptive filter using DCT (Discrete Cosine Transform). In this case, the adaptive algorithm of the adaptive filter may be an LMS (Least Mean Square) algorithm of DCT.

Alternatively, the adaptive filter may be an adaptive filter using FFT. In this case, the adaptive algorithm of the adaptive filter may be an LMS algorithm of FFT. The LMS algorithm gives an advantage of reducing a calculation amount relative to a projection algorithm and an RLS (Recursive Least Square) algorithm, and the LMS algorithm of DCT requires only calculation of real numbers, and therefore gives an advantage of reducing an amount of calculation relative to the LMS algorithm of FFT which requires calculation of complex numbers.

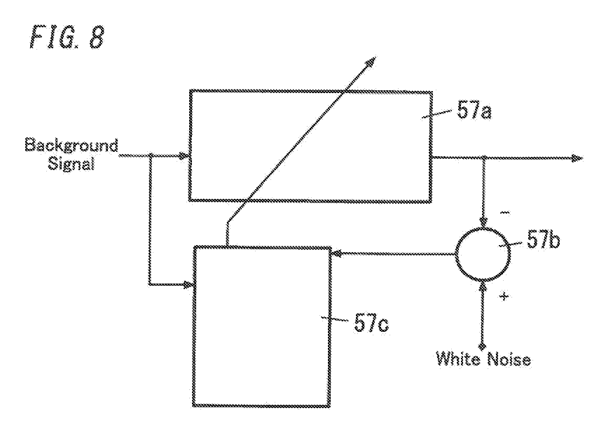

The adaptive filter has a configuration shown in FIG. 8, for example. This adaptive filter includes a filter 57a, a subtractor 57b, and an adaptive processor 57c. The filter 57a has a variable filter coefficient. The subtractor 57b outputs an error signal defined by a difference between an output signal of the filter 57a and a reference signal. The adaptive processor 57c generates a correction coefficient of a filter coefficient based on an input signal and the error signal according to the adaptive algorithm, and updates the filter coefficient. When background signals caused by thermal noises are given as an input signal of the filter 57a and the reference signal is a desired white noise, the adaptive filter can remove undesired background signals by filtering undesired background signals.

Further, by appropriately setting a forgetting factor of the adaptive filter, the background signal remover 52h may extract a frequency distribution of a signal obtained by filtering a long-term average background signal in a frequency axis. The forgetting factor is used in the calculation of updating the filter coefficient in order to exponentially decrease weights of previous data (filter coefficient) as the previous data is further away from the current data (filter coefficient), and exponentially increase weights of the previous data (filter coefficient) as the previous data is closer to the current data in the calculation of updating the filter coefficient. The forgetting factor is a positive number smaller than one, and for example is selected from a range of about 0.95 to 0.99.

The recognizer 52e performs the recognition process of detecting motions of the human body based on the distribution in the frequency domain of the normalized intensities obtained by filtering by the filter banks 5a and normalizing by the normalizer 52d. In this regard, the meaning of “detect” includes “classify”, “recognize”, and “identify”.

The recognizer 52e detects the motions of the human body by performing a pattern recognition process by principle component analysis, for example. This recognizer 52e operates according to a recognition algorithm using the principle component analysis. In order to operate such a type of recognizer 52e, the signal processor 52 preliminarily obtains learning data of a case where the human body is not present in the detection area of the sensor 51 and pieces of learning data individually corresponding to different motions of the human body (e.g., entering and leaving the room, and sitting on the seat) (learning). Further, the signal processor 52 preliminarily stores in a database device 52i, sample data obtained by performing the principle component analysis on pieces of the learning data. In this regard, the sample data stored in the database device 52i in advance may include data used for pattern recognition, which means category data associating the motion of the object, the projection vector, and a determination border value with each other. Note that, the sample data resulting from the learning data corresponding to the entering and leaving the room correspond to first sample data. The sample data resulting from the learning data corresponding to the sitting on the seat correspond to second sample data.

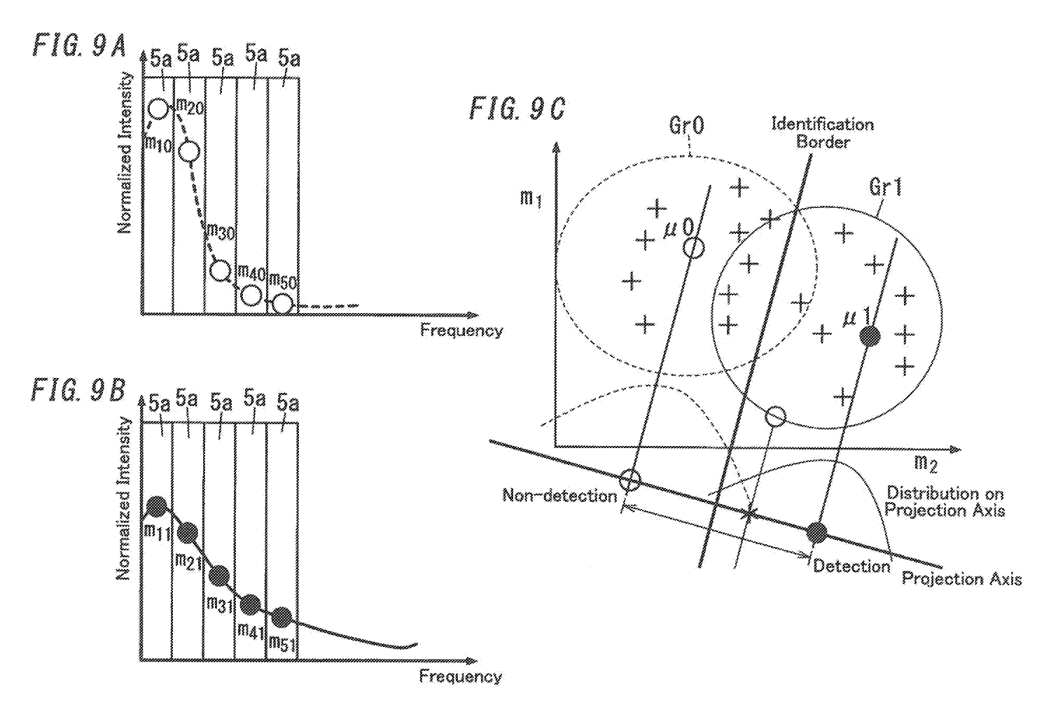

For convenience of explanation, it is assumed that FIG. 9A shows a distribution in the frequency domain of the normalized intensities corresponding to the sample data of the case where the human body is not present in the detection area of the sensor 51. Additionally, FIG. 9B shows a distribution in the frequency domain of the normalized intensities corresponding to the sample data of predetermined motion of the human body present in the detection area. In FIG. 9A, the normalized intensities of the signals passing through the individual filter banks 5a are represented by m₁₀, m₂₀, m₃₀, m₄₀ and m₅₀ from the lower frequency side. In FIG. 9B, the normalized intensities of the signals passing through the individual filter banks 5a are represented by m₁₁, m₂₁, m₃₁, m₄₁ and m₅₁ from the lower frequency side. In each of FIG. 9A and FIG. 9B, the sum of the normalized intensities of the signals passing through the three filter banks 5a on the lower frequency side is defined as a variable m₁, and the sum of the normalized intensities of the signals passing through the two filter banks 5a on the higher frequency side is defined as a variable m₂. In short, in FIG. 9A, m₁ is equal to m₁₀+m₂₀+m₃₀, and m₂ is equal to m₄₀+m₅₀. Further, in FIG. 9B, m₁ is equal to m₁₁+m₂₁+m₃₁, and m₂ is equal to m₄₁+m₅₁.

To imaginarily explain a two dimensional scatter diagram with orthogonal coordinate axes representing the two variables of m₁ and m₂, a projection axis, and a recognition border, FIG. 9C shows a two-dimensional graph of them. In FIG. 9C, a coordinate position of a scatter point (“+” in FIG. 9C) inside a region encircled by a broken line is represented by μ0 (m₂, m₁) and a coordinate position of a scatter point (“+” in FIG. 9C) inside a region encircled by a solid line is represented by μ1 (m₂, m₁). In the principle component analysis, a group Gr0 of data corresponding to the sample data of the case where the human body is not present in the detection area of the sensor 51 and a group Gr1 of data corresponding to the sample data of the predetermined motion of the human body present in the detection area are decided in advance. Further, in the principle component analysis, in FIG. 9C, the projection axis is determined to satisfy a condition that a difference between averages of distributions (schematically shown by a broken line and a solid line) of data obtained by projecting, onto the projection axis, the scatter points inside the regions encircled by the broken line and the solid line is maximized, and a further condition that variances of the distributions are maximized. Thus, in the principle component analysis, a projection vector can be obtained for individual sample data.

The recognizer 52e tries to detect the object based on the frequency domain distribution of the normalized intensities normalized by the normalizer 52d. In this case, the recognizer 52e performs the recognition process of detecting the predetermined motion of the human body based on comparison between the sample data and the detection data containing the frequency domain distribution of the normalized intensities normalized by the normalizer 52d. The recognizer 52e retrieves, from the database device 52i, the sample data corresponding to motion to be detected, and uses the retrieved sample data in the recognition process.

Besides, the signal processor 52 includes an outputter 52m configured to output the detection result from the recognizer 52e. When the recognizer 52e recognizes the predetermined motion of the human body, the outputter 52m outputs an output signal indicating that the predetermined motion of the human body has been detected. When the recognizer 52e does not recognize the human body in the detection area, the outputter 52m outputs an output signal indicating that the object to be detected has not been detected yet.

In FIG. 1, components of the signal processor 52 except the amplifier 52a, the A/D converter 52b, the outputter 52m and the database device 52i can be realized by the microcomputer performing appropriate programs.

It is preferable that the signal processor 52 allows change of the aforementioned determination border value according to settings inputted from the outside. Accordingly, the signal processor 52 can adjust required probabilities of miss detection and false detection according to usage.

In the aforementioned signal processor 52, the frequency analyzer 52c converts the sensor signal (time axis signal) outputted from the A/D converter 52b into the frequency domain signal, and extract, by use of the group of individual filter banks 5a with different frequency bands, signals of the individual filter banks 5a from the frequency domain signal. The recognizer 52e performs the recognition process of detecting the predetermined motion of the human body based on comparison between the sample data and the detection data containing the frequency distribution of intensities of signals based on the signals of the individual filter banks 5a.

Even when the sensor signal has a short time period (e.g., several tens of ms) in which the frequency analysis such as DCT is performed, the sensor signal shows a unique frequency distribution (statistical distribution in a frequency domain) which differs among the motions of the human body. When the feature of the frequency distribution is used for detection of the motion of the human body, the signal processor 52 can separate and recognize the motions different in the frequency distribution. Therefore, the signal processor 52 can reduce the probability of the false detection caused by unintended motion of the object of detection. In summary, the signal processor 52 can separate and detect the motions which are statistically different in the frequency distribution calculated from the intensities of the signals individually passing through the plurality of filter banks 5a, and thus the probability of the false detection can be reduced.

Further, in the filter bank 5a using FFT, in some cases, there is need to perform a process of multiplying a predetermined window function with the sensor signal before the FFT process, in order to reduce a side-lobe outside a desired frequency band (pass band). The window function may be selected from a rectangular window, a Gauss window, a hann window, and a hamming window, for example. In contrast, in the filter bank 5a using DCT, there is no need to use the window function. Therefore, the window function can be realized by a simple digital filter.

Further, the filter bank 5a using DCT is a process based on calculation of real numbers whereas the filter bank 5a using FFT is a process based on calculation of complex numbers (i.e., calculation of intensities and phases), and hence according to the filter bank 5a using DCT, an amount of calculation can be reduced. Further, in comparison between DCT and FFT with the same processing points, the frequency resolution of DCT is half of the frequency resolution of FFT. Hence, according to DCT, hardware resource such as the database device 52i can be down sized. For example, in the signal processor 52, when the sampling rate of the A/D converter 52b is 128 per second (e.g., the sampling frequency is 1 kHz), a DCT bin 5b has a width of 4 Hz whereas an FFT bin 5b has a width of 8 Hz. Note that, these numerical values are merely examples, and there is no intent of limitations.

The recognizer 52e may be configured to detect the object based on the pattern recognition process by the principle component analysis, or may be configured to detect the object based on another pattern recognition process. For example, the recognizer 52e may be configured to detect the object based on a pattern recognition process by KL transform, for example. When the signal processor 52 is configured so that the recognizer 52e performs the pattern recognition process by the principle component analysis or the pattern recognition process by KL transform, an amount of calculation at the recognizer 52e and an amount of a capacity of the database device 52i can be reduced.

Additionally or alternatively, the recognizer 52e may perform the recognition process of detecting the predetermined motion of the human body based on comparison between the sample data and the detection data containing a component ratio of normalized intensities of the signals of the individual filter banks 5a outputted from the normalizer 52d.

This type of recognizer 52e may be, for example, configured to detect the predetermined motion of the human body by performing the recognition process based on multiple linear regression analysis. In this case, the recognizer 52e operates according to a recognition algorithm using the multiple linear regression analysis.

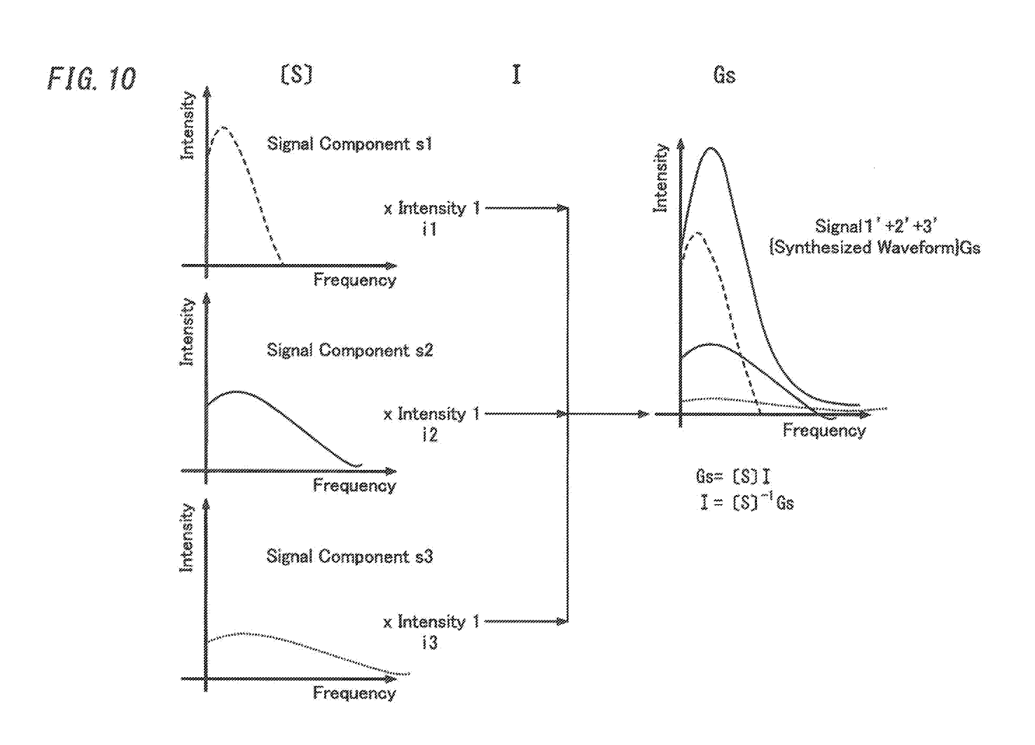

In order to use such a type of recognizer 52e, learning data corresponding to different motions of the human body in the detection area of the sensor 51 is preliminarily obtained (learning). Sample data obtained by performing the multiple linear regression analysis on the learning data is preliminarily stored in the database device 52i. FIG. 10 shows a synthesized waveform Gs of synthesis of a signal component s1, a signal component s2, and a signal component s3. According to the multiple linear regression analysis, the synthesized waveform Gs can be separated into the signal components s1, s2, and s3 by presumption, even when types of the signal components s1, s2, and s3, the number of signal components, and intensities of the signal components s1, s2, and s3 are unknown. In FIG. 10, [S] denotes a matrix whose matrix elements are the signal components s1, s2, and s3, and [S]⁻¹ denotes an inverse matrix of [S], and “I” denotes the component ratio (coefficient) of the normalized intensity. In this regard, the sample data preliminarily stored in the database device 52i serves as sample data used in the recognition process, and data associating the motion of the human body with the signal components s1, s2, and s3.

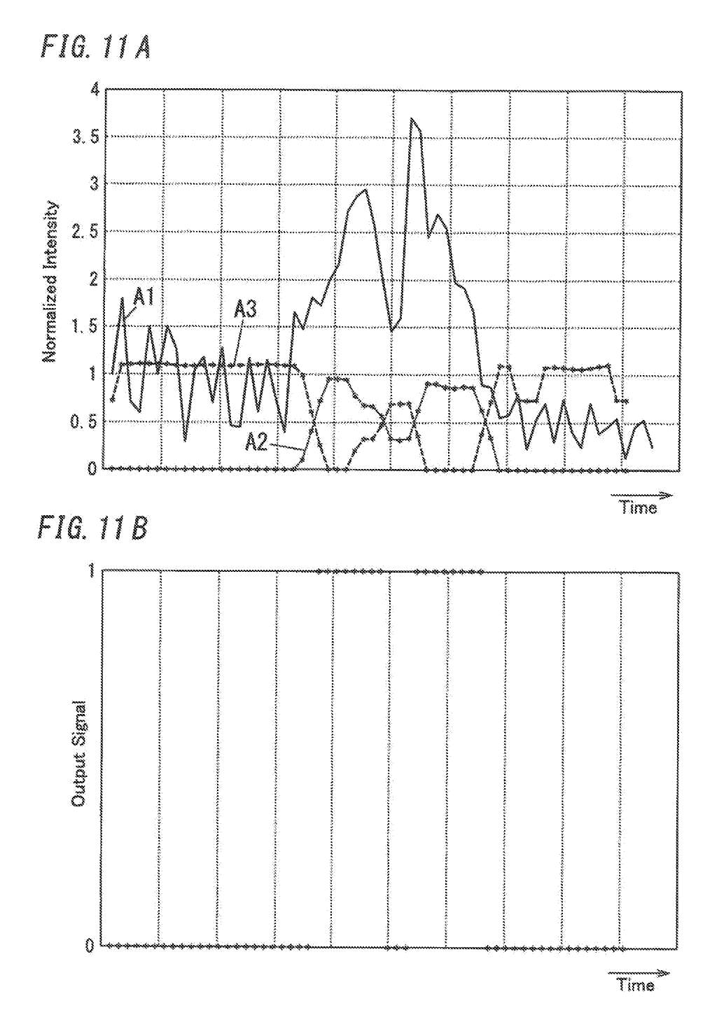

FIG. 11A shows a lateral axis denoting the time and a vertical axis denoting the normalized intensity. FIG. 11A shows A1 which represents data (corresponding to the aforementioned synthesized waveform Gs) in the time axis of the normalized intensities outputted from the normalizer 52d when a person makes the predetermined motion of the human body in the detection area. Further, FIG. 11A also shows signal components A2 and A3 which are separated from data A1 by the multiple linear regression analysis. In this regard, the signal component A2 is a signal component derived from the predetermined motion of the person, and the signal component A3 is a signal component derived from motion of another object.

The recognizer 52e performs the recognition process of detecting the predetermined motion of the human body based on comparison between the sample data and the detection data containing the component ratio (A2:A3) of the normalized intensities of the signals of the individual filter banks 5a outputted from the normalizer 52d. The recognizer 52e retrieves, from the database device 52i, the sample data corresponding to motion to be detected, and uses the retrieved sample data in the recognition process.

For example, FIG. 11B shows the output signal of the outputter 52m. In a case where A2 is larger than A3, the recognizer 52e determines that a person makes the predetermined motion of the human body, and thus the output signal of the outputter 52m has a high level (corresponding to “1”, for example). In a case other than the case where A2 is larger than A3, the recognizer 52e determines that a person does not make the predetermined motion of the human body, and thus the output signal of the outputter 52m has a low level (corresponding to “0”, for example). As apparent from FIG. 11B, it is confirmed that the probability of the false detection caused by an object other than the predetermined motion of the human body can be reduced.

It is preferable that the signal processor 52 allows change of the aforementioned determination condition (A2>A3) according to settings inputted from the outside. For example, it is preferable that the determination condition is set to A2>α× A3 and the coefficient α be allowed to be changed according to the settings inputted from the outside. Accordingly, the signal processor 52 can adjust required probabilities of miss detection and the false detection according to usage.

Note that, the recognizer 52e may be configured to detect motion of the human body based on the feature of the aforementioned frequency distribution and the component ratio of the normalized intensities. Therefore, the signal processor 52 can have the improved identification accuracy by the recognizer 52e.

Further, the signal processor 52 may be configured to allow the recognizer 52e to perform the recognition process or treat the recognition result by the recognizer 52e as being valid, only when the sum of intensities of signal components of a plurality of predetermined filter banks 5a before normalization by the normalizer 52d is equal to or more than a threshold value. Alternatively, the signal processor 52 may be configured to allow the recognizer 52e to perform the recognition process or treat the recognition result by the recognizer 52e as being valid, only when the weighted sum of intensities of signal components of a plurality of predetermined filter banks 5a before normalization by the normalizer 52d is equal to or more than a threshold value.

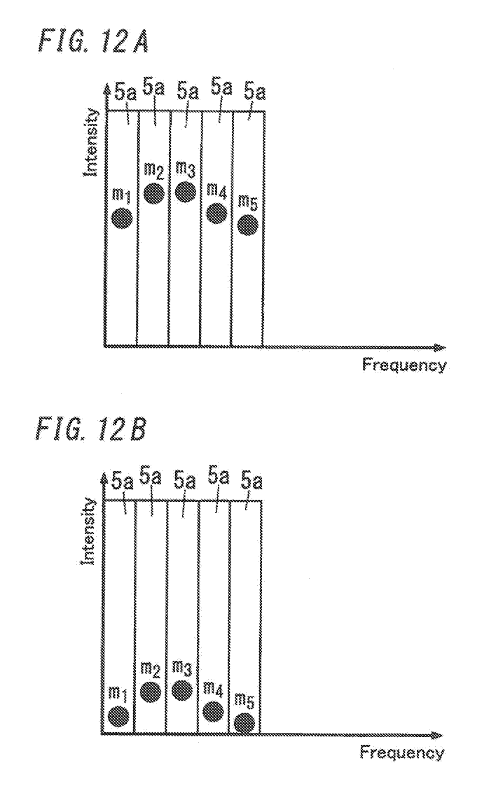

FIG. 12A and FIG. 12B relates to examples in which the intensities of the signals of the individual filter banks 5a before being normalized by the normalizer 52d are represented by m₁, m₂, m₃, m₄ and m₅ from the lower frequency side. FIG. 12A shows an example in which the sum of intensities [m₁+m₂+m₃+m₄+m₅] is equal to or larger than the threshold value E1. FIG. 12B shows an example in which the sum of intensities [m₁+m₂+m₃+m₄+m₅] is smaller than the threshold value E1.

Accordingly, the signal processor 52 can reduce the probability of the false detection. For example, the recognizer 52e is configured to detect the predetermined motion of the human body based on the frequency distribution derived from the normalized intensities of the signal components. In this case, when a person does not actually make the predetermined motion of the human body in the detection area but background noise is inputted, there is a probability that the recognizer 52e determines that the feature of the frequency distribution of the intensities of the signals at this time resembles the feature of the frequency distribution of a case where a person makes the predetermined motion of the human body in the detection area, and thus causes the false detection. In view of this, to reduce the probability of the false detection, the signal processor 52 determines whether to perform the recognition process, based on pre-normalized intensities of signals.

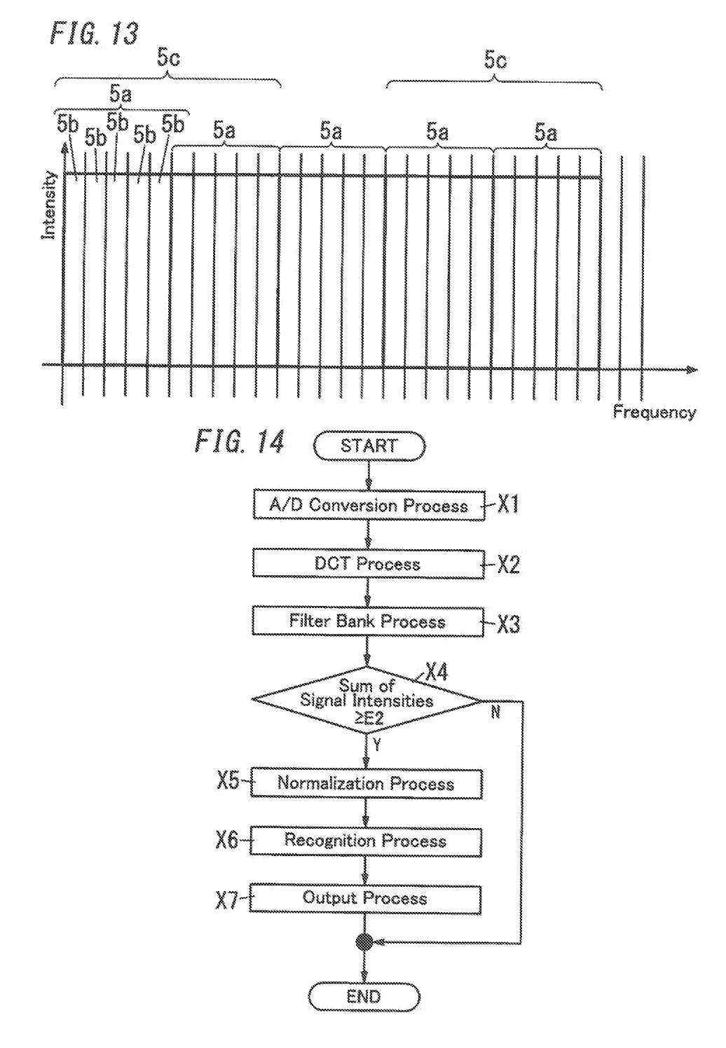

Further, a plurality of predetermined filter banks 5a before normalization by the normalizer 52d may be treated as one group 5c of filter banks (see FIG. 13). In this case, the signal processor 52 may determine whether the sum or weighted sum of pre-normalized intensities of signal components is equal to or more than a threshold value E2 for each of a plurality of groups 5c of filter banks. In more detail, the signal processor 52 may be configured to, only when, with regard to any of the groups 5c of filter banks, the sum of pre-normalized intensities of signal components is equal to or more than the threshold value E2, allow the recognizer 52e to perform the recognition process or treat a result of the recognition process by the recognizer 52e as being valid. Or, the signal processor 52 may be configured to, only when, with regard to all of the groups 5c of filter banks, the sum or weighted sum of pre-normalized intensities of signal components is equal to or more than the threshold value E2, allow the recognizer 52e to perform the recognition process or treat a result of the recognition process by the recognizer 52e as being valid. Hereinafter, a series of processes including this determination process is described with reference to a flow chart shown in FIG. 14. Note that, hereinafter, the phrase “the sum or weighted sum of pre-normalized intensities of signal components” is abbreviated as the sum of pre-normalized intensities of signal components.

First, the A/D converter 52b performs an A/D conversion process of converting the sensor signal amplified by the amplifier 52a into the digital sensor signal and outputting the digital sensor signal (X1). Next, the frequency analyzer 52c performs a filter bank process of converting the sensor signal outputted from the A/D converter 52b into the frequency domain signal (frequency axis signal) by DCT process (X2) and extracting signals of the individual filter banks 5a (X3). For example, in a case of DCT with 128 points, it is considered that one hundred twenty eight frequency bins 5b are divided into bundles of five frequency bins 5b and thus twenty five filter banks 5a are obtained.

Next, for example, as shown in FIG. 13, with regard to each of two groups 5c of filter bank on the lower frequency side and the higher frequency side, the signal processor 52 calculates the sum of pre-normalized intensities of signals of a plurality of filter banks 5a constituting the group 5c of filter banks. Thereafter, the signal processor 52 performs a threshold-based determination process of determining whether the sum of intensities of signals is equal to or larger than the threshold value E2 for each group 5c of filter banks (X4).

When the sum of intensities of signals of any of the groups 5c of filter banks is equal to or larger than the threshold value E2, the signal processor 52 determines that the amplitude of the sensor signal outputted from the sensor 51 is large and therefore the possibility that the sensor signal is derived from background noise is low, and performs a normalization process by the normalizer 52d (X5). In short, the normalizer 52d normalizes intensities of signals passing through the individual filter banks 5a and outputs normalized intensities.

Thereafter, the recognizer 52e of the signal processor 52 performs the recognition process of recognizing the feature of the distribution of intensities of signal of individual frequency components of the plurality of filter banks 5a obtained by normalization, and determining whether the feature is derived from the predetermined motion of the human body (X6). When the recognizer 52e recognizes the predetermined motion of the human body, the outputter 52m performs an output process of outputting the detection signal (X7).

In contrast, when the sum of intensities of signals of each of all the groups 5c of filter banks is smaller than the threshold value E2, the signal processor 52 determines that the amplitude of the sensor signal outputted from the sensor 51 is small and therefore the possibility that the sensor signal is derived from background noise is high. When determining that the possibility that the sensor signal is derived from background noise is high, the signal processor 52 does not perform subsequent processes including the normalization process by the normalizer 52d (X5 to X7).

As described above, the toilet bowl apparatus 1 and the toilet seat apparatus 12 of the present embodiment include the aforementioned human body detector 5, and thus can reduce undesired effect of background noise different from motion of the human body (e.g., noise derived from a commercial power supply, a mechanical signal of the toilet bowl apparatus 1, a fluctuation of a water surface inside the bowl 11a, and a noise of the lighting fixture).

Consequently, the toilet bowl apparatus 1 and the toilet seat apparatus 12 which include the aforementioned human body detector 5 can detect various motions of a human body (e.g., entering and leaving the restroom and sitting on and rising from the toilet seat 12b, of the user) accurately while suppressing false detection.

The following description referring to FIG. 15 is made to operation of the controller 6 using the detection result of the human body detector 5.

Initially, when a person does not exist in the restroom and the human body detector 5 does not detect a human body in the restroom, the controller 6 of the toilet bowl apparatus 1 operates in a waiting mode. The controller 6 in the waiting mode controls the flusher 11c to set a level of water stored in the bowl 11a to a low level, and controls the lighting controller 11g to turn off the lighting fixture in the restroom, and controls the lifter 11h to move the toilet seat 12b and the toilet lid 12c to their down positions. Further, the controller 6 in the waiting mode terminates operations of the bottom washer 11d and the detergent supplier 11f.

When the human body detector 5 detects the human body of a person entering the restroom, the controller 6 transitions from the waiting mode to a presence mode (J1). After transition from the waiting mode to the presence mode, the controller 6 controls the lighting controller 11g to turn on lighting in the restroom, and controls the lifter 11h to move the toilet lid 12c to the up-position or the toilet seat 12b and the toilet lid 12c to the up-positions. Additionally, after detecting entering to the room, the recognizer 52e selects a value (first threshold value) for the presence mode as the threshold value E2 (or the threshold value E1) used in the aforementioned threshold-based determination process.

When the person comes close to the toilet bowl 11 and then the human body detector 5 detects the human body of the person stopping in an immediate vicinity of the sensor 51 (the antennas 51c and 51d), the human body detector 5 determines the human body of the person sitting on the toilet seat 12b, and then the controller 6 transitions from the presence mode to a sitting mode (J2). After detecting sitting on the seat, the recognizer 52e selects a value (second threshold value) for the sitting mode as the threshold value E2 (or the threshold value E1) used in the aforementioned threshold-based determination process.

When the signal processor 52 recognizes transition from the presence mode to the sitting mode, the frequency analyzer 52c performs a process for the sitting mode. Then, a respiration detector 52j determines a condition of respiration of the human body of the person sitting on the toilet seat 12b, based on the analysis result of the frequency analyzer 52c. In other words, the respiration detector 52j tries to detect micromotion of the human body (J3).

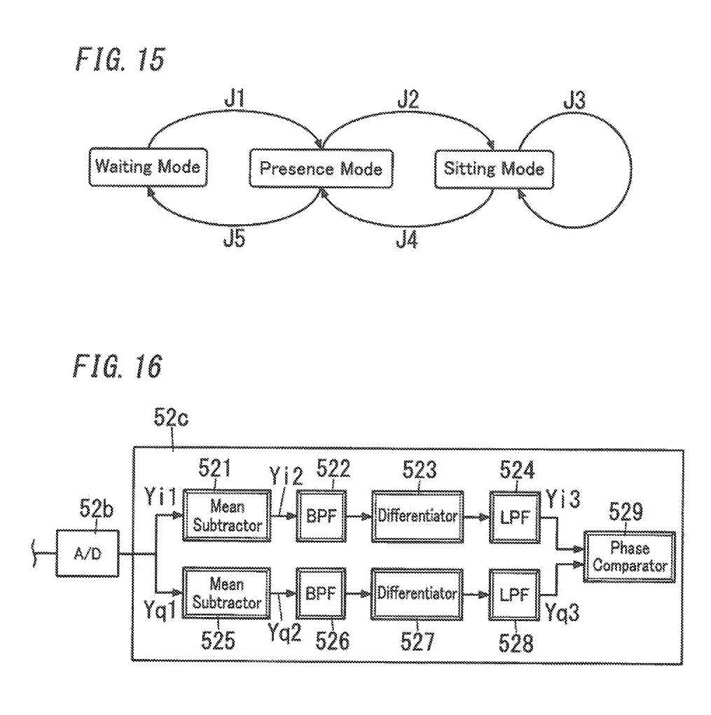

In the sitting mode, the frequency analyzer 52c executes functions of mean subtractors 521 and 525, bandpass filters 522 and 526, differentiators 523 and 527, low-pass filters 524 and 528, and a phase comparator 529 shown in FIG. 16.

The frequency analyzer 52c uses the signals of two channels outputted from the receiver 51e which are an in-phase component Yi1 (In Phase) and a quadrature phase component Yq1 (Quadrature Phase) of the sensor signal.

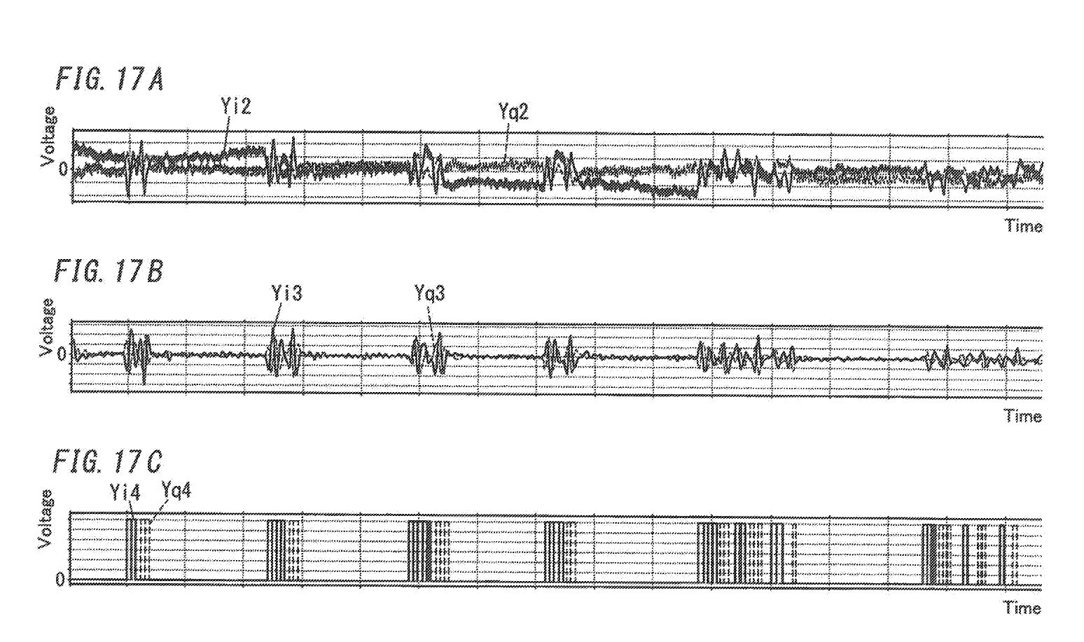

The mean subtractor 521 subjects the in-phase component Yi1 to a mean subtraction process to give an in-phase component Yi2 (see FIG. 17A). The in-phase component Yi2 is filtered with the bandpass filter 522 allowing passage of a predetermined frequency band component, and is subjected to a differentiating process by the differentiator 523, and then is filtered with the low-pass filter 524. Thus, an in-phase component Yi3 (see FIG. 17B) is given. The in-phase component Yi3 is inputted into the phase comparator 529.

The mean subtractor 525 subjects the quadrature phase component Yq1 to a mean subtraction process to give a quadrature phase component Yq2 (see FIG. 17A). The quadrature phase component Yq2 is filtered with the bandpass filter 526 allowing passage of a predetermined frequency band component, and is subjected to a differentiating process by the differentiator 527, and then is filtered with the low-pass filter 528. Thus, a quadrature phase component Yq3 (see FIG. 17B) is given. The quadrature phase component Yq3 is inputted into the phase comparator 529.

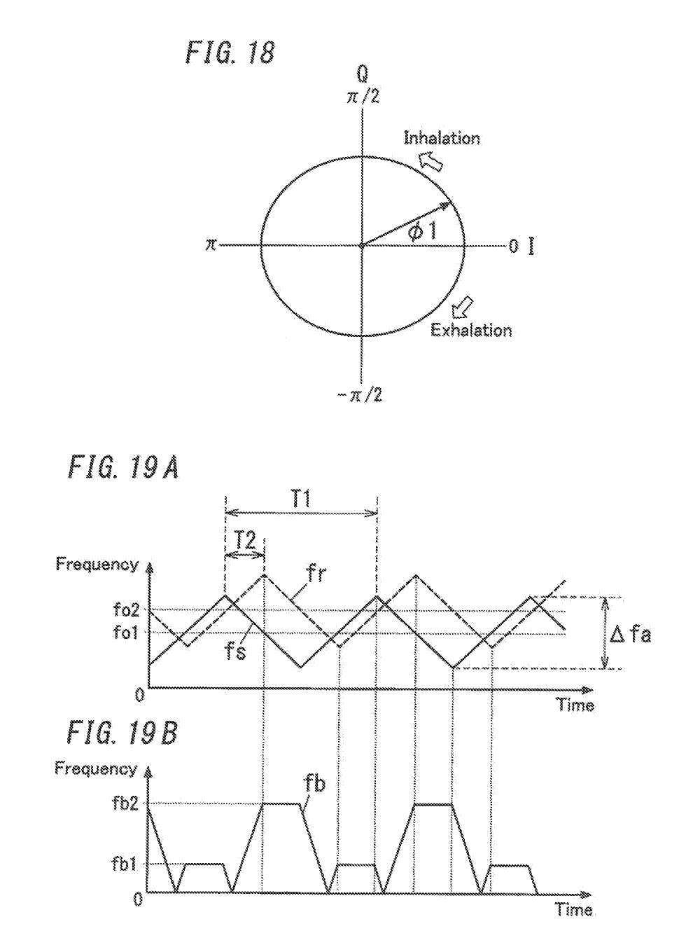

The phase comparator 529 calculates a phase difference φ1 between the in-phase component Yi3 and the quadrature phase component Yq3 (see FIG. 18), and generates an inhalation signal Yi4 indicative of an inhalation condition of breathing in and an exhalation signal Yq4 indicative of an exhalation condition of breathing out, based on the phase difference φ1 (see FIG. 17C). In FIG. 18, the phase difference φ1 larger than 0 indicates the inhalation condition, and the phase difference φ1 smaller than 0 indicates the exhalation condition. Note that, a value [dφ1/dt] being a time derivative of the phase difference φ1 means a Doppler frequency.

The respiration detector 52j tries to detect respiration of a person sitting on the seat based on pattern of presence of the inhalation signal Yi4 and the exhalation signal Yq4. Even when the human body of the person sitting on the seat remains at rest, the recognizer 52e can still detect the human body of the person sitting on the seat as long as the respiration detector 52j detects respiration (i.e., detects micromotion of the human body).

When a situation where the respiration detector 52j detects the respiration continues for a predetermined time period after transition to the sitting mode, the controller 6 in the sitting mode controls the flusher 11c to change the level of water stored in the bowl 11a from the low level to a high level. Alternatively, the controller 6 in the sitting mode may control the flusher 11c to change the level of water stored in the bowl 11a to a middle level tentatively and then change it to the high level. Additionally, the controller 6 in the sitting mode controls the detergent supplier 11f to mix detergent in flushing water to improve flushing effect of the bowl 11a.

When the recognizer 52e continues the recognition process, and the recognizer 52e detects large motion of the human body, and the respiration detector 52j does not detect respiration, the controller 6 in the sitting mode determines rising from the seat which means that the human body rises from the toilet seat 12b. Then, the controller 6 transitions from the sitting mode to the presence mode (J4). After detecting rising from the seat, the recognizer 52e selects the value for the presence mode as the threshold value E2 (or the threshold value E1) used in the aforementioned threshold-based determination process. After transition from the sitting mode to the presence mode, when the bottom washer 11d is in use, the controller 6 stops supply of water to the washing nozzle 11e and accommodates the washing nozzle 11e. Additionally, after a lapse of a fixed time period from transition from the sitting mode to the presence mode, the controller 6 controls the flusher 11c to flush the bowl 11a.

When the human body detector 5 detects the human body of the person leaving the restroom, the controller 6 in the presence mode transitions from the presence mode to the waiting mode (J5). After transition from the presence mode to the waiting mode, the controller 6 controls the lighting controller 11g to turn off lighting of the restroom, and controls the lifter 11h to move the toilet seat 12b and the toilet lid 12c to the down-positions. Additionally, after detecting leaving the room, the recognizer 52e selects a value for the waiting mode as the threshold value E2 (or the threshold value E1) used in the aforementioned threshold-based determination process.

Additionally, the signal processor 52 includes a distance meter 52k configured to measure a distance to the human body based on the output of the frequency analyzer 52c. Further, the signal processor 52 includes a direction detector 52l configured to detect a moving direction (approaching or departing) of the human body, based on the output of the frequency analyzer 52c.

FIG. 19A to FIG. 21D show brief operation of the distance meter 52k.

Initially, the transmission controller 51a of the sensor 51 repeats a sweep process of increasing and then decreasing a frequency fs of a radio wave (transmission signal) sent from the transmitter 51b. The frequency fs of the transmission signal depends on a variation width Δfa, a center frequency fo1, and a sweep cycle T1 (see FIG. 19A).

The receiver 51e receives a reflected wave (reception signal) after time T2=2W/C, where W denotes a distance between the sensor 51 and the human body, and C denotes light speed (see FIG. 19A). The reception signal has a frequency fr which depends on the variation width Δfa and the sweep cycle T1 in a similar manner to the frequency fs of the transmission signal. Further, the reception signal has a center frequency fo2=[fo1+{(2*fo1*Vr)/C}], where Vr denotes an approaching speed of the human body.

The receiver 51e generates a beat signal with a frequency fb equal to a difference between the frequency fs of the transmission signal and the frequency fr of the reception signal and outputs the beat signal (see FIG. 19B).

When both the frequency fs of the transmission signal and the frequency fr of the reception signal increase, the frequency fb of the beat signal is given by a relation of fb=fb1=[(4*Δfa*W)/(C*T1)]−[(2*fo1*Vr)/C]. In the above formula, the first term represents positional information indicative of the distance from the human body detector 5 to the human body, and the second term represents speed information indicative of a speed of the human body approaching the human body detector 5.

When both frequencies of the transmission signal and the reception signal decrease, the frequency fb of the beat signal is given by a relation of fb=fb2=[(4*Δfa*W)/(C*T1)]+[(2*fo1*Vr)/C]. In the above formula, the first term represents positional information indicative of the distance from the human body detector 5 to the human body, and the second term represents speed information indicative of a speed of the human body approaching the human body detector 5.

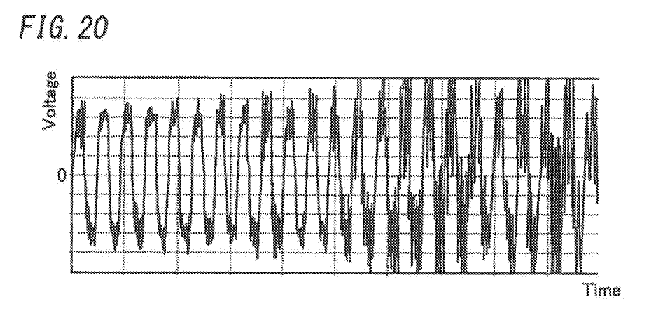

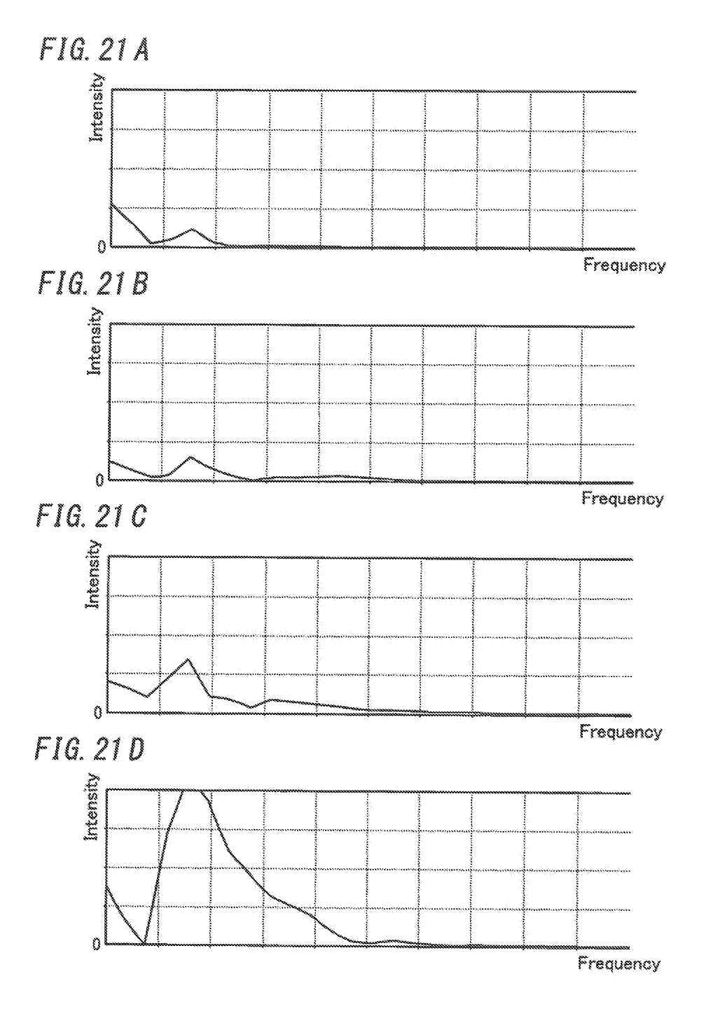

The frequency analyzer 52c subjects the beat signal (see FIG. 20) to a frequency analyzing process. FIG. 21A to FIG. 21D show waveforms of the beat signals subjected to the frequency analyzing process by the frequency analyzer 52c. Change of the waveform in the order from FIG. 21A, FIG. 21B, FIG. 21C, and FIG. 21D shows that the human body approaches the human body detector 5.

The distance meter 52k measures the distance from the sensor 51 to the human body, based on the beat signal subjected to the frequency analyzing process. The recognizer 52e performs the recognition process in combination with distance information (measurement result) generated by the distance meter 52k, and thus can determine a position of the human body. Accordingly, the recognizer 52e can identify and recognize the individual motions of the human body accurately.

Additionally, the direction detector 52l determines the moving direction (approaching and departing) of the human body, based on the output of the frequency analyzer 52c. The recognizer 52e performs the recognition process in combination with direction information given by the direction detector 52l, and thus can determine the moving direction of the human body. Accordingly, the recognizer 52e can identify and recognize the individual motions of the human body accurately. The direction detector 52l can determine the moving direction of the human body by a similar process to the respiration detector 52j or differences between pieces of the distance information.

Additionally, the toilet bowl apparatus 1 may have an external setting function of setting an area of detecting motion of the human body according to an external input in view of a size of the restroom.

It is preferable that the sensor 51 (the transmission antenna 51c, the reception antenna 51d) be attached on a sitting side of the toilet seat 12b. For example, it is preferable that the sensor 51 be provided to the toilet seat body 12a positioned on back of the human body of the person sitting on the toilet seat 12b. In a case where a flush tank for storing water to be supplied into the toilet bowl 11 is provided on back of the human body of the person sitting on the toilet seat 12b, it is preferable that the sensor 51 be provided to the flush tank.

It is preferable that each of the transmission antenna 51c and the reception antenna 51d be placed so as to have its antenna face extending in a vertical direction or a direction considered vertical. Further, the directions of the antenna faces of the transmission antenna 51c and the reception antenna 51d can be changed according to a selected one of the waiting mode, the presence mode, and the sitting mode. In this case, detection sensitivity of motion of the human body can be improved.

The aforementioned human body detector 5 may not be limited to being included in the toilet seat apparatus 12, but may be included in the toilet bowl apparatus 1 or the remote controller 3.

### SUMMARY

(1) As described above, the toilet seat apparatus 12 includes: the toilet seat body 12a (body) to be placed on the toilet bowl 11; the toilet seat 12b attached to the toilet seat body 12a so as to be movable between an up-position and a down-position; and the human body detector 5 configured to detect a human body as an object to be detected. The human body detector 5 includes the sensor 51 configured to send the wireless signal and receive the wireless signal reflected by the object to output the sensor signal corresponding to motion of the object. The human body detector 5 further includes the frequency analyzer 52c. The frequency analyzer 52c is configured to convert the sensor signal into the frequency domain signal, and extract, by use of the group of individual filter banks 5a with different frequency bands, signals of the individual filter banks 5a from the frequency domain signal. The human body detector 5 further includes the recognizer 52e. The recognizer 52e is configured to perform the recognition process of detecting predetermined motion of the human body based on the detection data containing at least one of the frequency distribution of signals based on the signals of the individual filter banks 5a and the component ratio of signal intensities based on the signals of the individual filter banks 5a. The human body detector 5 further includes the database device 52i configured to store the sample data containing at least one of the frequency distribution corresponding to the predetermined motion of the human body and the component ratio of signal intensities corresponding to the predetermined motion of the human body. The recognizer 52e includes the first detection function of detecting, by performing the recognition process based on comparison between the detection data and the sample data, the human body of the person entering the space in which at least the toilet bowl 11 is installed, and the second detection function of detecting, by performing the recognition process based on comparison between the detection data and the sample data, the human body of the person sitting on the toilet seat 12b.

According to this configuration, the toilet seat apparatus includes the human body detector capable of detecting various motions of a human body accurately while suppressing false detection. The toilet seat apparatus thus can offer effect of detecting accurately various motions of a human body such as entering and leaving the restroom and sitting on and rising from the toilet seat.

(2) In a preferable configuration of the toilet seat apparatus 12 of the above (1), the sample data includes first sample data and second sample data. The recognizer 52e is configured to use the first sample data when performing the first detection function, and use the second sample data when performing the second detection function.

According to this configuration, the toilet seat apparatus 12 can detect motion of a human body accurately while suppressing false detection.

(3) In a preferable configuration of the toilet seat apparatus 12 of the above (1) or (2), the recognizer 52e is configured to, when a sum of intensities of the signals of the individual filter banks 5a is equal to or larger than a threshold value, perform the recognition process or treat a result of the recognition process as being valid. The threshold value includes the first threshold value (value for the presence mode) and the second threshold value (value for the sitting mode) different from the first threshold value. The recognizer 52e is configured to use the first threshold value as the threshold value when performing the first detection function, and use the second threshold value as the threshold value when performing the second detection function.

According to this configuration, the toilet seat apparatus 12 can detect motion of a human body accurately while suppressing false detection.

(4) In a preferable configuration of the toilet seat apparatus 12 of any one of the above (1) to (3), the toilet seat apparatus 12 further includes the background signal remover 52h configured to remove background signals from signals individually passing through the individual filter banks 5a.

According to this configuration, the toilet seat apparatus 12 can offer improvement of the detection accuracy of the human body.

(5) In a preferable configuration of the toilet seat apparatus 12 of any one of the above (1) to (4), the toilet seat apparatus 12 further includes the distance meter 52k configured to measure a distance to the human body based on the sensor signal. The recognizer 52e is configured to perform the recognition process in combination with a measurement result of the distance meter 52k.

According to this configuration, the recognizer 52e can perform the recognition process in combination with the measurement result generated by the distance meter 52k, and thus can determine a position of the human body. Accordingly, the recognizer 52e can identify and recognize the individual motions of the human body accurately. Additionally, it is possible to remove unnecessary signals from an outside of the desired area.

(6) In a preferable configuration of the toilet seat apparatus 12 of any one of the above (1) to (5), the toilet seat apparatus 12 further includes the direction detector 52l configured to detect a moving direction of the human body, based on the sensor signal. The recognizer 52e is configured to perform the recognition process in combination with a detection result of the direction detector 52l.

According to this configuration, the recognizer 52e can perform the recognition process in combination with the moving direction determined by the direction detector 52l, and thus can identify presence of the human body. Accordingly, the recognizer 52e can identify and recognize the human body accurately.

(7) In a preferable configuration of the toilet seat apparatus 12 of any one of the above (1) to (6), the toilet seat apparatus 12 further includes the respiration detector 52j configured to determine a condition of respiration of the human body of a person sitting on the toilet seat 12b, based on the sensor signal.

According to this configuration, the toilet seat apparatus 12 can determine sitting on the seat of the human body based on respiration detected by the respiration detector 52j.

(8) In a preferable configuration of the toilet seat apparatus 12 of any one of the above (1) to (7), the sensor 51 is provided to face a back of the human body of a person sitting on the toilet seat 12b.

According to this configuration, the toilet seat apparatus 12 can detect the human body.

(9) In a preferable configuration of the toilet seat apparatus 12 of any one of the above (1) to (8), the toilet seat apparatus 12 further includes the normalizer 52d. The normalizer 52d is configured to normalize intensities of the signals individually passing through the individual filter banks 5a by a sum of the signals extracted by the frequency analyzer 52c or a sum of intensities of signals individually passing through predetermined filter banks 5a selected from the individual filter banks 5a to obtain normalized intensities. The normalizer 52d is configured to output the normalized intensities. The recognizer 52e is configured to perform the recognition process of detecting the predetermined motion of the human body based on at least one of a frequency distribution and a component ratio of the normalized intensities which are calculated from the normalized intensities of the individual filter banks 5a outputted from the normalizer 52d.

According to this configuration, the toilet seat apparatus 12 can detect the predetermined motion of the human body based on at least one of the frequency distribution and the component ratio of the normalized intensities which are calculated from the normalized intensities of the individual filter banks 5a.

(10) The toilet bowl apparatus 1 include: the toilet seat apparatus 12 of any one of the above (1) to (9); and the toilet bowl 11 on which the toilet seat body 12a (body) of the toilet seat apparatus 12 is placed.

Consequently, the toilet bowl apparatus 1 and the toilet seat apparatus 12 include the human body detector 5 capable of detecting various motions of a human body accurately while suppressing false detection, and thus can detect accurately various motions of a human body such as entering and leaving the restroom and sitting on and rising from the toilet seat.

(11) In a preferable configuration of the toilet bowl apparatus 1 of the above (10), the toilet bowl apparatus 1 further includes the controller 6 configured to control operation of a water supply device (the flusher 11c and the bottom washer 11d) for supplying water into the toilet bowl 11 based on a detection result of the human body detector 5.

According to this configuration, the toilet bowl apparatus 1 can control operation of the water supply device based on the detection result of the human body detector 5.

(12) In a preferable configuration of the toilet bowl apparatus 1 of the above (11), the toilet bowl apparatus 1 includes the flush tank for storing water to be supplied into the toilet bowl 11. The flush tank is to face the back of the human body of the person sitting on the toilet seat 12b. The sensor 51 is provided to the flush tank.

According to this configuration, the toilet bowl apparatus 1 can detect the human body.

1. A toilet seat apparatus comprising:
a body to be placed on a toilet bowl;
a toilet seat attached to the body so as to be movable between an up-position and a down-position; and
a human body detector configured to detect a human body as an object to be detected,
the human body detector including
a sensor configured to send a wireless signal and receive the wireless signal reflected by an object to output a sensor signal corresponding to motion of the object,
a frequency analyzer configured to convert the sensor signal into a frequency domain signal, and extract, by use of a group of individual filter banks with different frequency bands, signals of the individual filter banks from the frequency domain signal,
a recognizer configured to perform a recognition process of detecting predetermined motion of the human body based on detection data containing at least one of a frequency distribution of signals based on the signals of the individual filter banks and a component ratio of signal intensities based on the signals of the individual filter banks, and
a database device configured to store sample data containing at least one of a frequency distribution corresponding to the predetermined motion of the human body and a component ratio of signal intensities corresponding to the predetermined motion of the human body, and
the recognizer including
a first detection function of detecting, by performing the recognition process based on comparison between the detection data and the sample data, the human body of a person entering a space in which at least the toilet bowl is installed, and
a second detection function of detecting, by performing the recognition process based on comparison between the detection data and the sample data, the human body of a person sitting on the toilet seat.

2. The toilet seat apparatus of claim 1, wherein:
the sample data including first sample data and second sample data different from the first sample data; and
the recognizer is configured to use the first sample data when performing the first detection function, and use the second sample data when performing the second detection function.

3. The toilet seat apparatus of claim 1, wherein:
the recognizer is configured to, when a sum of intensities of the signals of the individual filter banks is equal to or larger than a threshold value, perform the recognition process or treat a result of the recognition process as being valid;
the threshold value includes a first threshold value and a second threshold value different from the first threshold value; and
the recognizer is configured to use the first threshold value as the threshold value when performing the first detection function, and use the second threshold value as the threshold value when performing the second detection function.

4. The toilet seat apparatus of claim 1, further comprising a background signal remover configured to remove background signals from signals individually passing through the individual filter banks.

5. The toilet seat apparatus of claim 1, further comprising a distance meter configured to measure a distance to the human body based on the sensor signal,
the recognizer being configured to perform the recognition process in combination with a measurement result of the distance meter.

6. The toilet seat apparatus of claim 1, further comprising a direction detector configured to detect a moving direction of the human body, based on the sensor signal,
the recognizer being configured to perform the recognition process in combination with a detection result of the direction detector.

7. The toilet seat apparatus of claim 1, further comprising a respiration detector configured to determine a condition of respiration of the human body of a person sitting on the toilet seat, based on the sensor signal.

8. The toilet seat apparatus of claim 1, wherein
the sensor is provided to face a back of the human body of a person sitting on the toilet seat.

9. The toilet seat apparatus of claim 1, further comprising a normalizer configured to normalize intensities of the signals individually passing through the individual filter banks by a sum of the signals extracted by the frequency analyzer or a sum of intensities of signals individually passing through predetermined filter banks selected from the individual filter banks to obtain normalized intensities, and output the normalized intensities,
the recognizer being configured to perform the recognition process of detecting the predetermined motion of the human body based on at least one of a frequency distribution and a component ratio of the normalized intensities which are calculated from the normalized intensities of the individual filter banks outputted from the normalizer.

10. A toilet bowl apparatus comprising:
the toilet seat apparatus of claim 1; and
the toilet bowl on which the body of the toilet seat apparatus is placed.

11. The toilet bowl apparatus of claim 10, further comprising a controller configured to control operation of a water supply device for supplying water into the toilet bowl based on a detection result of the human body detector.

12. The toilet bowl apparatus of claim 11, further comprising a flush tank for storing water to be supplied into the toilet bowl, the flush tank being to face a back of the human body of a person sitting on the toilet seat, and
the sensor is provided to the flush tank.
